(19) United States
(12) Patent Application Publication
(10) Pub. No.: US 2021/0160095 A1
(43) Pub. Date: May 27, 2021

(54) Communication System for Providing Communication Between a Control Module and an Oil and/or Gas Module

(71) Applicant: FMC Kongsberg Subsea AS, Kongsberg (NO)

(72) Inventors: Vidar Nicolaysen, Kongsberg (NO); Thomas André Karlberg, Drammen (NO)

(21) Appl. No.: 16/618,323

(22) PCT Filed: Jun. 6, 2018
(86) PCT No.: PCT/EP2018/064907

§ 371 Date: Nov. 29, 2019

(30) Foreign Application Priority Data
Jun. 14, 2017 (NO) 20170964

(51) Int. Cl. H04L 12/40; H04L 29/08; H04L 12/931

(52) U.S. Cl. CPC H04L 12/40182; E21B 33/0355; H04L 49/35; H04L 67/12

(57) ABSTRACT

The present invention relates to a communication system (10) for providing communication between a control module (6) having a connection interface (11) with a plurality of connectors (12) releasably connectable to a connection interface (2a) of an oil and/or gas module (2). The communication system (10) comprises a first electronic communication unit (20) providing a first type of communication via the connection interface (11) and a second electronic communication unit (30) providing a second type of communication via the connection interface (11). The system (10) further comprises a reconfiguration unit (40) connected between the connectors (12) and the first and second electronic communication units (20, 30) for reconfiguration of the connections between the respective connectors (12) and the first and second electronic communication units (20, 30).

### FIELD OF THE INVENTION

The present invention relates to a communication system for providing communication between a control module and an oil and/or gas module.

### BACKGROUND OF THE INVENTION

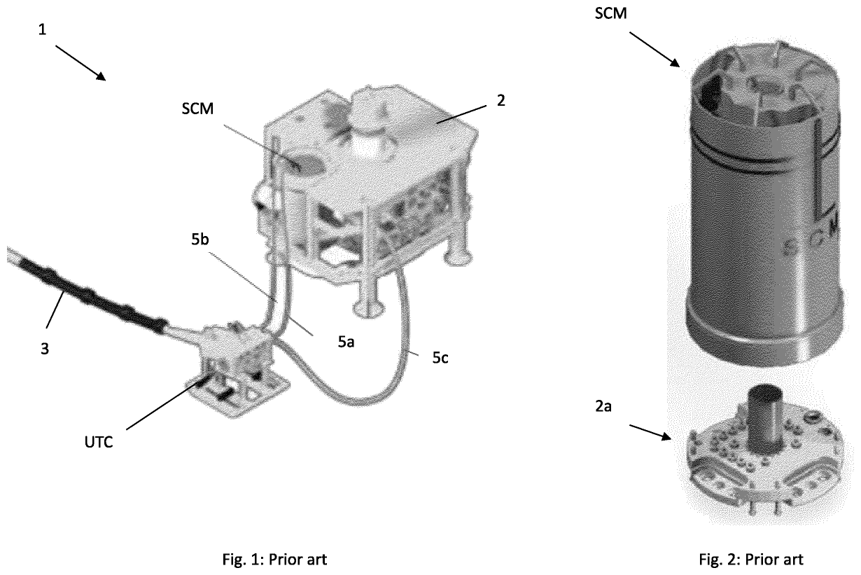

Different types of subsea modules are used in subsea oil/gas installations. In FIG. 1, a part of a subsea oil/gas installation 1 is shown, with one typical oil and/or gas module 2 in the form of a Christmas tree connected to a well head (not shown) of an oil/gas well. In FIG. 1, it is shown that the Christmas tree 2 is connected to an umbilical termination assembly (UTC) via a communication jumper 5a, electrical jumper 5b, and hydraulic/chemical jumper 5c. An umbilical 3 is connected between the UTC and a topside installation (not shown).

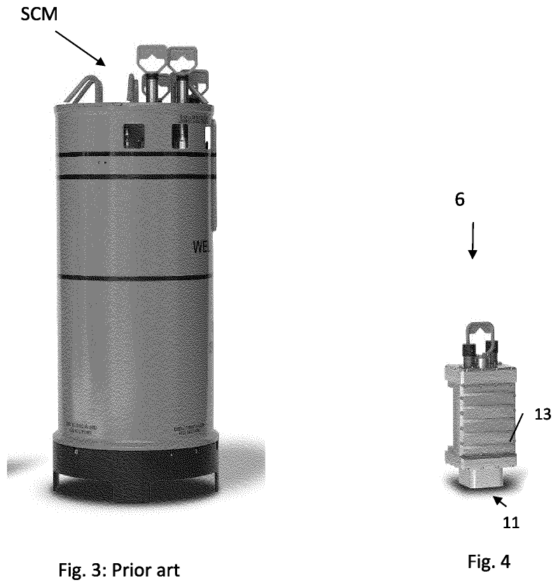

A control module (SCM) is connected to a connection interface 2a (FIG. 2) of the Christmas tree 2. The SCM shown in FIGS. 2 and 3 has been manufactured and sold by FMC Subsea Technologies for many years. The SCM contains electronics, instrumentation, and hydraulics for safe and efficient operation of subsea tree valves, chokes, and also downhole valves in the well.

The SCM comprises several connectors for connection between the SCM and the connection interface 2a of the subsea module 2. These connectors are AC and/or DC power connectors, high pressure and/or low pressure hydraulic connectors and communication connectors.

Today, the owner and/or operator and/or legislator of the respective oil/gas field have different requirements for the subsea modules and its SCMs. Accordingly, almost all SCMs are tailor-made for its specific subsea module, which contributes to manufacturing costs and a substantial delivery time.

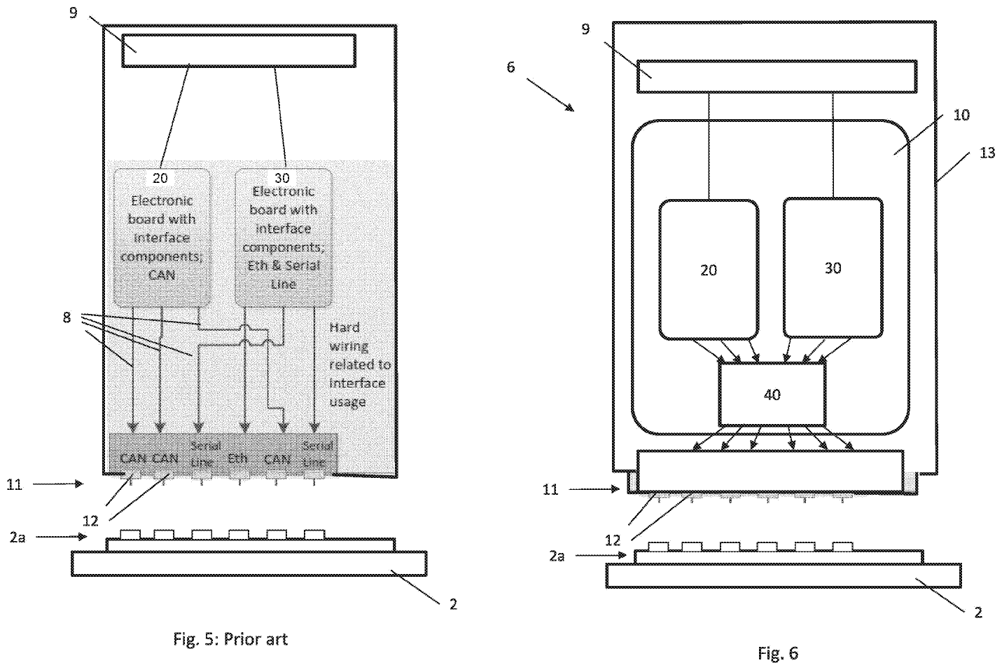

In FIG. 5, the connection interface 11 comprising communication connectors 12 of the SCM is illustrated schematically. Here, there are six communication connectors where three of them are using CAN bus communication, two of them are using for serial line communication and one is using Ethernet communication. The communication connectors 12 are hard-wired by means of wires 8 to the respective electronic communication units 20, 30 used to input/output signals via the communication connectors 12. The wiring of these communication connectors is done according to specifications by the operator and will therefore vary from field installation to field installation, which reduces the flexibility.

The oil and gas industry is facing several challenges with respect to reducing costs for subsea equipment and subsea operations. Hence, one object is to reduce the size and cost of control devices for subsea modules and their control modules. Another object of the invention is to standardize the design of such control modules while at the same time allowing the owner and/or operator of the oil/gas field to adapt the control modules according to their specifications.

One way of adapting a control module to several oil and/or gas modules is to use an adapter, as known from U.S. Pat. No. 8,720,576. Here, the same control module may be used for different oil and/or gas modules, since the adapter is connected between the control module and the oil and/or gas module. The adapter contains hydraulic fluid lines, communication lines and electrical power lines for transferring hydraulic fluid, communication signals and electric power between the control module and the oil and/or gas module. This adapter will increase the weight of the overall system. Moreover, if there are many different possible configurations of the oil and/or gas module, many different adapters will be needed.

One object of the present invention is to reduce the number of project specific variants of such modules, which in turn will reduce the costs and workload required for testing such variants. Hence, one object is to increase the standardization of such modules and/or to increase the flexibility of such control modules.

Another object of the present invention is to reduce the weight of such control modules, or at least avoid increasing the weight of such control modules.

### SUMMARY OF THE INVENTION

The present invention relates to a communication system for providing communication between a control module having a connection interface with a plurality of connectors releasably connectable to a connection interface of an oil and/or gas module, where the communication system comprises:
a first electronic communication unit providing a first type of communication via the connection interface;
a second electronic communication unit providing a second type of communication via the connection interface;
   characterized in that the system further comprises a reconfiguration unit connected between the connectors and the first and second electronic communication units for reconfiguration of the connections between the respective connectors and the first and second electronic communication units.

In one aspect, the first type of communication is different from the second type of communication. However, the types of communication may be of the same type for redundancy purposes.

According to the invention described above, it is achieved that the hardware of the first and second electronic communication units can be standardized and these units are not dependent on the types of connectors defined by a specific project. Accordingly, the communication system of the control module may be adapted to the respective specification of the module in a simple and efficient way. The disadvantages of the extra adaptor unit of prior art described above is also avoided.

In one aspect, the reconfiguration unit is configured to perform configuration and/or reconfiguration of the connections between the respective connectors and the first and second electronic communication units by changing the software in the reconfiguration unit. In this way, only a change in software is necessary to reconfigure the communication types used by the connectors of the control module.

In one aspect, the reconfiguration unit comprises a plurality of multiplexer units, each multiplexer unit having an output terminal connected to one of the connectors, input terminals connected to the first and second electronic communication units and a control terminal connected to a control unit. The control unit is preferably a software control unit.

In one aspect, the electronic communication units and the reconfiguration unit are provided within a pressure-sealed housing, where the connectors of the connection interface are provided on the outside of the housing.

In one aspect, the first and second electronic communication units are providing communication by means of one of either CAN-bus communication, Ethernet communication, RS 422 communication, RS 485 communication or 4-20 mA communication.

In one aspect, the connectors are separated into a first group of connectors and a second group of connectors where the reconfiguration unit is provided for allowing connection of only one of the first or second electronic communication units to the first group of connectors.

In one aspect, each connector comprises several connector pins, where the reconfiguration unit is providing reconfiguration of the connections between the respective connector pins of the connectors and the first and second electronic communication units.

### DETAILED DESCRIPTION

Embodiments of the invention will now be described with reference to the enclosed drawings, where:

FIG. 1 illustrates a part of a prior art subsea oil/gas installation;

FIG. 2 illustrates a perspective view of the prior art control module and its connection interface on the subsea module;

FIG. 3 illustrates a side view of the prior art oil and/or gas module;

FIG. 4 illustrates a perspective view of the subsea control module;

FIG. 5 illustrates schematically the communication connectors and electronic communication units in a prior art SCM;

FIG. 6 illustrates schematically the communication system of the subsea control module of FIG. 4;

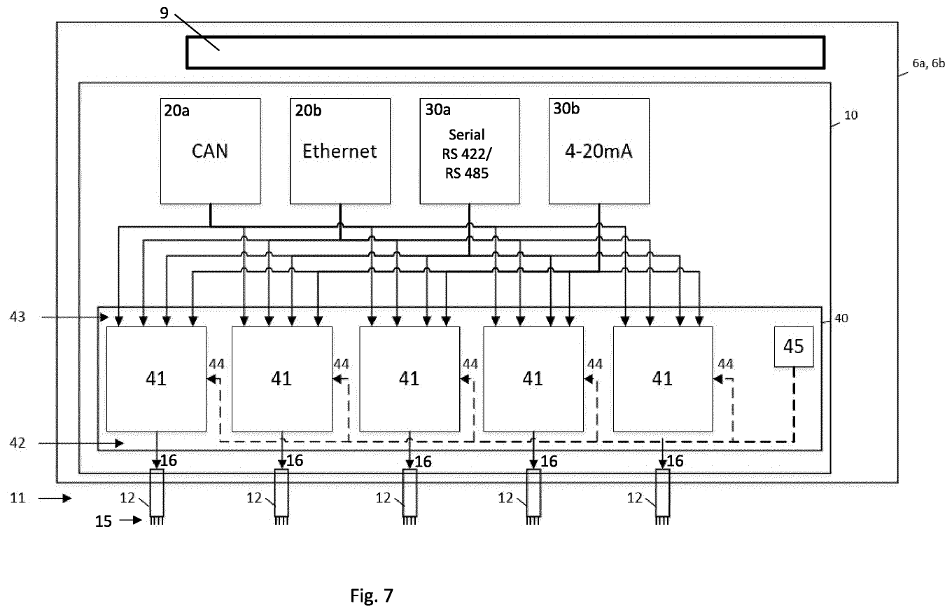

FIG. 7 illustrates schematically one embodiment of the reconfiguration unit of FIG. 6.

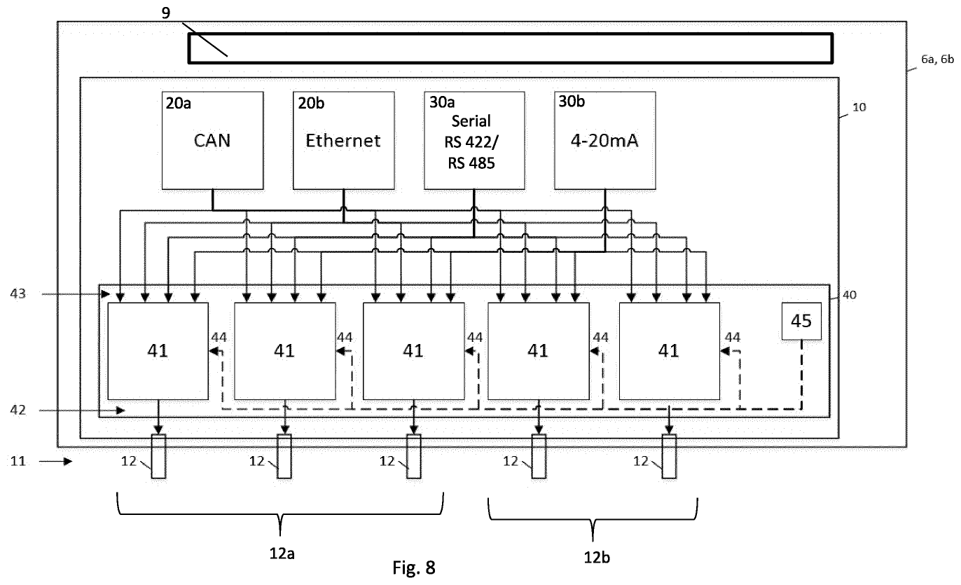

FIG. 8 illustrates schematically an alternative embodiment of the reconfiguration unit of FIG. 6.

It is now referred to FIG. 6. Here, a subsea control module 6, corresponding to the subsea control module 6 of FIG. 4, is shown schematically, comprising an outer housing 13 and a communication system 10 provided within the housing 13. The communication system 10 is providing communication between the control module 6 and an oil and/or gas module 2 controlled by the control module 6.

The present embodiment relates to a subsea control module 6 for controlling a subsea oil and/or gas module 2. However, the communication system 10 may also be used for communication between land-based control modules for controlling land-based oil and/or gas modules 2. The housing 13 is a pressure-compensated housing 13 with a connection interface 11 provided on the outside of, and in the lower part of, the housing 13. The connection interface 11 comprises a plurality of communication connectors 12 for releasable connection of the control module 6 to the oil and/or gas module 2. Hence, the control module 6 may be lowered onto, or elevated up from, a connection interface 2a of the oil and/or gas module 2. The subsea module 2 can be a manifold unit, a Christmas tree unit, a subsea umbilical termination unit, an electrical distribution module (EDM), a pipeline end manifold unit (PLEM), a boosting station, a riser base unit and other subsea modules which needs a supply of electric power and/or needs to send sensor signals.

The communication device 10 comprises communication units 20, 30. The electronic communication units 20, 30 are connected to a control system generally referred to with reference number 9 in FIGS. 7 and 8. The control system 9 receives signals via the electronic communication units 20, 30 and may be configured to forward the received signals to the topside control center, to perform certain actions based on the received signals etc. Moreover, the control system 9 sends signals to the oil and/or gas module 2.

The first electronic communication unit 20 is providing a first type of communication via the connection interface 11, while the second electronic communication unit 30 providing a second type of communication via the connection interface 11. Of course, more than two electronic communication units may be provided. In FIG. 8 it is shown an embodiment with four communication units 20a, 20b, 30a, 30b. Examples of types of communication are CAN bus communication (CAN FT, CAN HS), Ethernet communication, 4-20 mA communication, RS485/422 communication or other communication standards. Some of these communication types are also a part of the subsea instrumentation interface standardization (SIIS).

In FIG. 6 it is also shown that the communication system 10 comprises a reconfiguration unit 40 connected between the connection interface 11 and the first and second electronic communication units 20, 30. The reconfiguration unit 40 is performing a reconfiguration of the connections between the respective connectors 12 and the first and second electronic communication units 20, 30. The reconfiguration unit 40 is preferably an electronic reconfiguration unit. Preferably, the reconfiguration may be performed by changing the software in the electronic reconfiguration unit. Accordingly, the communication system 10 of the control module 6 may be adapted to the respective specification of the module 2 in a simple and efficient way. The disadvantages of the extra adaptor unit of prior art described above is also avoided. In addition, it is achieved that the hardware of the communication device 10 can be generic for every project, where only the software is affected by project configuration.

It is now referred to FIG. 7 Here it is shown that the reconfiguration unit 40 comprises a plurality of multiplexer units 41, where each multiplexer unit 41 has an output terminal 42, several input terminals 43 and a control terminal 44. The multiplexer unit 41 will provide a connection between the output terminal 42 and one of the input terminals 43 depending on the control signal received via its control terminal 44.

The output terminal 42 of one multiplexer unit 41 is connected to one of the respective connectors 12. Hence, each of the connectors 12 is connected to a multiplexer unit 41. The input terminals 43 of the multiplexer unit 41 is connected to the electronic communication units 20a, 20b, 30a, 30b. The control terminal 44 of each multiplexer unit 41 is connected to a control unit 45.

By means of the control unit 45 it is now possible to configure and reconfigure which connector 12 that should be connected to which of the electronic communication units 20a, 20b, 30a, 30b. As mentioned above, configuration and reconfiguration may be performed by changing the software in the control unit 45.

In FIG. 7 it is shown that the first and second electronic communication units are providing communication by means of one of either CAN-bus communication, Ethernet communication, RS 422 communication, RS 485 communication or 4-20 mA communication. These communication types are considered known for a skilled person and will not be described here further in detail.

Preferably, each connector 12 is connected to at least two electronic communication units, where the type of communication used by the first communication unit is different from the type of communication used by the second communication unit. However, for redundancy purposes, a connector 12 may also have the possibility to be connected to two different electronic communication units that are using the same type of communication. Moreover, it is of course possible to let one or more of the connectors 12 to be directly connected to a communication unit 20a, 20b, 30a, 30b, i.e. that no multiplexer unit 41 is involved in transferring the signal for that or those connectors 12.

It should also be noted that FIG. 7 is somehow simplified by showing only one communication wire connected between each of communication units 20a, 20b, 30a, 30b to the respective multiplexer units 41. In reality, most communication units will require at least two such connection wires. The CAN-bus communication standard requires for example four communication wires. Other communication types require a point-to-point connection, i.e. branching of physical wires is not allowed.

Another simplification of FIG. 7 is that only one communication wire 16 is shown connected to each connector 12. Typically, each connector 12 will have twelve connection pins 15 (only four shown in FIG. 8) with corresponding connection wires. Accordingly, as the number of multiplexer units 41 may be equal to the number of pins 15, the number of multiplexer units 41 will be much higher than shown in FIG. 8. Hence, it will be possible to reconfigure the connection pins 15 of one connector 12 by means of the reconfiguration unit 40. It will also be possible to use more than one communication type via the different connection pins 15 of one connector 12.

It is now referred to FIG. 8. In some situations, some of wires used to transport communication signals in the module 2 and/or the control module 6 may have physical limitations restricting some wires to be able to transport one or two types of communication signals. Here, some of the connectors may only be allowed to use a limited set of communication types. In FIG. 8 it is shown a first group 12a of connectors 12 (comprising three connectors) and a second group 12b of connectors 12 (comprising two connectors), where the reconfiguration unit 40 is configured only to allow communication between the first group 12a of connectors 12 and electronic communication units 20a, 20b, while the reconfiguration unit 40 is configured only to allow communication between the second group 12b of connectors 12 and electronic communication units 30a, 30b. Again, this type of limitation can be controlled by software within the control unit 45. Alternatively, this type of limitation may be achieved by a change in hardware, by removing some of the connection wires between the communication units 20a, 20b, 30a, 30b and the respective multiplexer units 41.

It should be noted that the communication units 20, 30 and the reconfiguration unit 40 may be provided as separate electronic circuits on separate printed circuit boards within the housing 13. However, it s also possible to provide the communication units 20, 30 and the reconfiguration unit 40 on the same printed circuit board within the housing 13.

In the description above, all connectors 12 are communication connectors. However, it should be noted that the connectors 12 typically comprises several pins, where some pins are used for communication and other pins are used for transferring electric energy between the control module 6 and the subsea module 2. It should be noted that only the communication pins are connected to the reconfiguration unit (40).

1: A communication system for providing communication between a control module and an oil and/or gas module, the control module having a first connection interface with a plurality of connectors and the oil and/or gas module having a second connection interface to which the first connection interface is releasably connectable, the communication system comprising:
a first electronic communication unit providing a first type of communication via the first connection interface;
a second electronic communication unit providing a second type of communication via the first connection interface; and
a reconfiguration unit connected between the connectors and the first and second electronic communication units for reconfiguration of the connections between the respective connectors and the first and second electronic communication units.

2: The communication system according to claim 1, wherein the reconfiguration unit comprises a plurality of multiplexer units, each multiplexer unit having an output terminal connected to one of the connectors, a number of input terminals connected to the first and second electronic communication units and a control terminal connected to a control unit.

3: The communication system according to claim 1, wherein the electronic communication units and the reconfiguration unit are provided within a pressure-sealed housing, and wherein the connectors of the first connection interface are provided on the outside of the housing.

4: The communication system according to claim 1, wherein the first type of communication is different from the second type of communication.

5: The communication system according to claim 4, where the first and second electronic communication units each provide communication by means of CAN-bus communication, Ethernet communication, RS 422 communication, RS 485 communication or 4-20 mA communication.

6: The communication system according to claim 1, wherein the connectors are separated into a first group of connectors and a second group of connectors, and wherein the reconfiguration unit is configured to allow for connection of only one of the first or second electronic communication units to the first group of connectors.

7: The communication system according to claim 1, where each connector comprises several connector pins, and wherein the reconfiguration unit is configured to reconfigure the connections between the respective connector pins and the first and second electronic communication units.

8: The communication system according to claim 1, wherein the reconfiguration unit is configured to perform configuration and/or reconfiguration of the connections between the respective connectors and the first and second electronic communication units by changing software in the reconfiguration unit.
